(19) United States
(12) Patent Application Publication
(10) Pub. No.: US 2008/0295902 A1
(43) Pub. Date: Dec. 4, 2008

(54) WATER RETENTION/DETENTION SYSTEM

(75) Inventors: Robert Henry Grey Faber, Yanderra (AU); Neil Edwin Wallace, Albion Park (AU)

Correspondence Address: MICHAEL BEST & FRIEDRICH LLP, 100 E WISCONSIN AVENUE, Suite 3300, MILWAUKEE, WI, 53202, US

(73) Assignee: BLUESCOPE STEEL LIMITED, Melbourne (AU)

(21) Appl. No.: 11/756,747

(22) Filed: Jun. 1, 2007

(51) Int. Cl. F16L 41/08; F16L 23/00

(52) U.S. Cl. 137/561 A; 285/405

(57) ABSTRACT

An underground water retention or detention system for collecting stormwater, rainwater, sewerage, effluent or other waters, and controlled release of the water is disclosed. Typically, the tanks are formed from a plastics or polymeric material such as high density polyethylene. The pipes may be polymer coated corrugated steel pipes. Tanks suitable for use in the water retention and detention systems are also described together with connection fittings for connection of pipes to the tanks. Generally, the connection fittings are adapted to provide structural support to perimeter walls of the tanks about respective openings formed in the tank for the connection of the pipes.

### FIELD OF THE INVENTION

The present invention broadly relates to a water retention or detention system and particularly, though not exclusively, to a stormwater retention or detention system. The invention further relates to storage tanks and connection fittings adapted for use in the water retention or detention system.

### BACKGROUND OF THE INVENTION

For both residential and commercial sites there is a requirement to provide adequate stormwater detention and water retention.

A typical stormwater detention system includes a soakwell which is plumbed to plastic conduits connected to major contributors of stormwater runoff, such as drains and roofing downpipes. The soakwell is buried below ground and is designed to collect large volumes of rainwater and allow for its gradual seepage into sand or aggregate within the soakwell. The soakwell may be constructed in-situ from interlocking concrete blocks or alternatively may be in the form of a tank. The problem with this traditional stormwater detention system is that its installation is labour intensive and time consuming.

Water retention systems are typically designed for storage of, for example, filtered rainwater to supplement mains water supply. Water detention systems are typically civil structures which connect to and rely on other systems such as effluent plant.

In one example of a known stormwater detention system, prefabricated corrugated steel pipes are connected to an underground corrugated steel tank. The corrugated pipes are connected to the tank via joining systems which, by nature of the corrugated surfaces to be joined, are relatively complex. The pipe and tank are of the same diameter and are fabricated from relatively light gauge steel strip. This known detention system suffers from one or more of the following drawbacks:
(i) connection of the corrugated pipe to the corrugated tank is difficult, requiring extensive work in-situ;
(ii) connection of the pipe to the tank weakens the otherwise inherently rigid corrugated tank; and
(iii) the connection of the pipe to the tank leaks water which is undesirable.

### SUMMARY OF THE INVENTION

In one aspect of the present invention there is provided an underground water retention or detention system, comprising:

at least one water storage tank adapted for being at least partially buried and having an access entry provided in an upper region of the tank and one or more openings into the interior of the tank provided in a lower region of the tank; and

at least one pipe for storing water and connected to the tank such that the pipe opens to the interior of the tank through a respective said opening, the pipe having a minimum cross-sectional dimension that is less than a dimension of the tank in a section of the tank to which the pipe is connected.

In another aspect of the present invention there is provided a storage tank of an underground water retention or detention system, the storage tank adapted for being at least partially buried, and including:

an access entry provided in an upper region of the tank and one or more openings to the interior of the tank provided in a perimeter wall of the tank in a lower region of the tank; and

a reinforcement fitting fitted to the or each opening providing structural support to the perimeter wall of the tank about the one or more openings.

In another aspect of the present invention there is provided an underground water retention or detention system, comprising:

a plurality of water storage tanks, each adapted for being at least partially buried and having an access entry provided in an upper region of the tank and one or more openings into the interior of the tank provided in a lower region of the tank; and

a plurality of connection fittings each dedicated to a respective one of the openings of the tanks and being adapted to provide for connection of a pipe for interconnection of ones of the tanks, the positioning of the openings in the tanks being dependent on the orientation of the pipe and relative disposition of the storage tanks to which the pipe is connected.

Preferably, the reinforcement fitting(s) and the connection fitting(s) are the same component and as such provide members for connecting the pipe(s) to respective of the tanks and reinforce the perimeter walls of the tanks about respective of the openings.

More preferably, the reinforcement/connection fitting(s) includes a ring member that is shaped complementary to the corresponding tank opening to fit within or about the opening and arranged to protrude from an outside surface of the tank to provide for connection of the corresponding pipe.

Even more preferably, the reinforcement fitting(s) includes an annular flange connected to the ring member and arranged to locate against an inside or outside surface of the tank about a periphery of the corresponding opening.

Alternatively, the connection fitting(s) is integrally formed with the tank within or about the opening. In this embodiment, the connection fitting(s) may serve to both reinforce the tank about the opening and provide members for connecting the pipe to the tank.

A connection fitting(s) can also be provided for connection of the pipe to the tank wherein the connection fitting(s) has an orifice that is smaller than the internal minimum cross-section of the pipe and is positioned so as to be offset downwardly with respect to the longitudinal axis of the pipe for alignment with the opening of the tank to allow water to empty from the pipe. Typically, the orifice will be located such that the bottom periphery of the orifice will be aligned with the bottom of the interior of the pipe. Offsetting the orifice of the connection fitting(s) allows pipes of larger minimum cross-sectional dimension to be fitted to the same tank without altering the location of the opening into the tank or the need to increase the size of the opening to accommodate larger pipes. Thus, water storage capacity of the water retention or detention system can be readily increased to suit the requirements of a water retention or detention system for a given site by simply selecting the pipe(s) from a range of pipes of different sizes.

Hence, in a further aspect of the present invention there is provided an underground water retention or detention system, comprising:

at least one water storage tank adapted for being at least partially buried, and having an access entry provided in an upper region of the tank and one or more openings into the interior of the tank provided in a lower region of the tank, the openings being of a predetermined size;

at least one pipe for storing water and having a minimum internal cross-section larger than respective of the openings; and

at least one connection fitting interposed between the pipe and the tank and connecting the pipe to the tank such that the pipe opens to the interior of the tank through a respective said opening, the or each connection fitting having an orifice smaller than the minimum cross-section of the pipe and which is offset downwardly with respect to a longitudinal axis of the pipe and aligned with the opening for allowing water to empty from the pipe.

In still another aspect of the present invention there is a method for providing an underground water retention or detention system, comprising:

providing at least one water storage tank adapted for being at least partially buried, the tank having an access entry in an upper region of the tank;

forming one or more openings to the interior of the tank in a lower region of the tank, the openings being of a predetermined size;

selecting at least one pipe for storing water, the pipe having an interior minimum cross-section larger than at least one of the openings;

providing a respective connection fitting for connecting the pipe to the tank, the connection fitting having an orifice smaller than the minimum cross-section of the pipe; and

connecting the pipe to the tank using the connection fitting such that the pipe opens to the interior of the tank through a corresponding said opening, the orifice of the connection fitting being offset downwardly with respect to the longitudinal axis of the pipe and aligned with the opening for allowing water to empty from the pipe when the pipe is connected to the tank by the connection fitting.

In a further aspect of the present invention there is provided a connection fitting suitable for connecting a water storage pipe to a water storage tank of an underground water retention and/or detention system, the tank having an access entry provided in an upper region of the tank and at least one opening into the interior of the tank provided in a lower region of the tank, wherein the connection fitting comprises an end cover for covering an open end of the pipe, the pipe having a minimum cross-section larger than the opening of the tank, and wherein the end cover has an orifice smaller than the minimum cross-section of the pipe and is adapted for alignment of the orifice with the opening in the tank.

Typically, the perimeter wall of the water storage tank of a retention or detention system of the invention will include at least one formation defining an outline of a region of the perimeter wall of a predetermined size for being removed to provide an opening in the tank at a predetermined location for connection of the pipe to the tank. By predefining the location and size of respective openings to be formed in the tank, the opening(s) can be formed in the tank in-situ or prior to delivery of the tanks to the site of installation, without the need to align the pipe with the tank or otherwise determine the location of the required opening(s) on site. As such, the risk of error in the installation process may be reduced as may the time required to install the water retention or detention system with consequential savings in installation costs.

Accordingly, in yet another aspect of the present invention there is provided a water storage tank suitable for an underground water retention and/or detention system, wherein the tank is adapted for being at least partially buried and has at least one fonnation provided in a predetermined location on a perimeter wall of the tank, the formation defining a region of the perimeter wall of predetermined size for being removed to provide an opening in the perimeter wall for connection of a water storage pipe to the tank such that the pipe opens to the interior of the tank through the opening.

The water storage tank(s) of embodiments of the invention will generally be dimensioned to permit worker access into the tanks for installation and subsequent maintenance of the water retention and/or detention system. Typically, each pipe connected to the tank can also be accessed from the tank through respective of the openings provided in the lower region of the tank for installation and maintenance of the pipe.

Preferably, the water storage tank is formed of a plastics or polymeric material such as high density polyethylene (HDPE).

Typically, the tank is an underground water storage tank.

Preferably, the, or each, pipe is a steel pipe and more preferably, a corrugated steel pipe.

Most preferably, the steel pipe is spiral wound and polymer coated.

The pipe is generally of a diameter from 900 mm to 1,500 mm.

However, the invention is not limited to pipes within this diameter range and pipes with larger diameters may be employed.

Moreover, the pipes of one or more water retention or detention systems embodied by the present invention may provide the primary water storage capacity of the systems.

By “water storage” in the context of a water detention system is meant the temporary storage of water accumulated in the system pending gradual or controlled release from the system, preferably to water catchment pit(s), dam(s) or drainage system(s).

Preferably, the water retention or detention system is a stormwater detention system. Alternatively, the water retention or detention system is a rainwater retention system for the provision of a supplemental water supply. In another application the retention or detention system is an effluent detention system.

For the purpose of this specification, water is to be understood to include stormwater, rainwater, sewerage, effluent and combinations of these liquids.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The features and advantages of the present invention will become further apparent from the following detailed description of preferred embodiments together with the accompanying drawings.

### BRIEF DESCRIPTION OF THE ACCOMPANYING DRAWINGS

FIG. 1 is a front, plan and side elevational view of a stormwater detention system embodied by the present invention;

FIG. 2 is a plan view of a rainwater retention system embodied by the present invention;

FIG. 3 is an elevational view of a storage tank of the retention or detention systems of FIG. 1 or FIG. 2;

FIG. 4 is an isometric view of the storage tank of FIG. 3;

FIG. 5 is an exploded perspective view of a connection fitting connecting a pipe to a water storage tank of a retention or detention system embodied by the present invention;

FIG. 6 is a rear view of an end cover of the connection fitting of FIG. 5;

FIG. 7 is a schematic plan view of alternative layouts of stormwater retention systems embodied by the present invention; and

FIG. 8 is a schematic plan view of yet another layout of a stormwater retention system embodied by the present invention.

### DETAILED DESCRIPTION OF PREFERRED EMBODIMENTS OF THE INVENTION

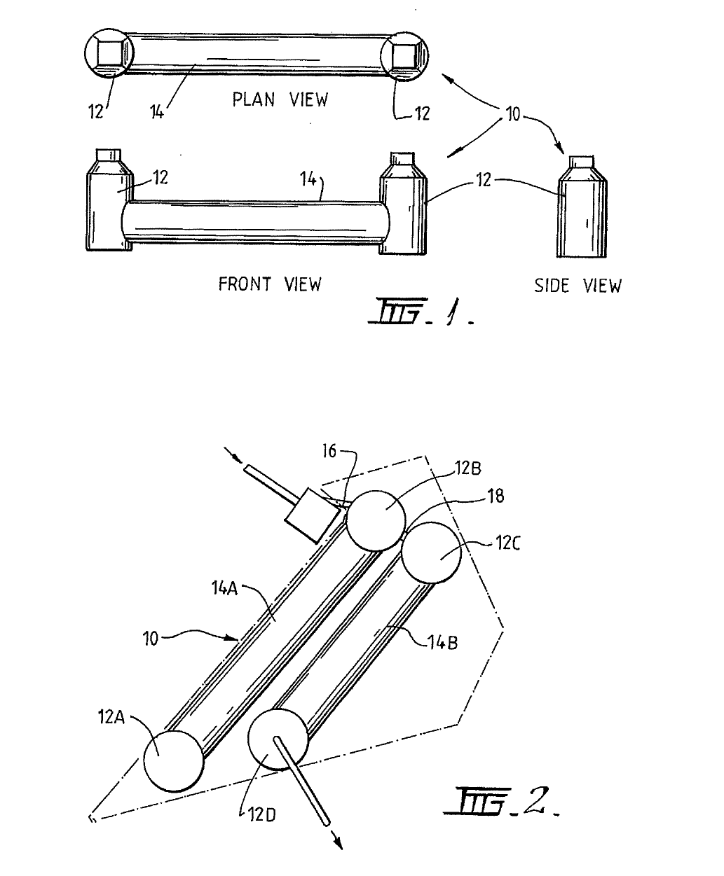

FIGS. 1 and 2 show water retention and detention systems in the form of stormwater detention and rainwater retention systems, respectively, designated generally by the numeral 10. In each of these embodiments, the retention or detention system 10 comprises one or more water storage tanks identified by the numerals 12, in FIG. 1 and by the numerals 12A/B/C in FIG. 2 connected to one or more pipes identified by the numeral 14 in FIG. 1 and by the numerals 14A/B in FIG. 2. The tanks and the pipes 14 are generally positioned underground, and the number of the tanks and their interconnection via the pipes is dependent on the particular application and site constraints.

In the stormwater detention system 10 of FIG. 1, there are two storage tanks 12 that are interconnected by one pipe 14. At least one of the tanks provides a controlled flow of stormwater to a stormwater catchment pit or system through a discharge overflow or from a small outlet portal (not shown) provided in a lower region of the tank. The stormwater detention system 10 of FIG. 1 can include additional tanks depending on the requirements of the site, and each tank 12 or “node” may be connected to multiple pipes such as 14 at different depths and angular positions.

The rainwater retention system 10 of FIG. 2 is designed to provide a supplementary water supply to, for example, an irrigation system. The retention system includes two pairs of storage tanks 12A/B and 12C/D with the tanks of each pair of tanks being interconnected by respective pipes 14A and 14B. One of the tanks 12B is connected to a rainwater inlet which provides a filtered water supply through the inlet line 16. The adjacent tanks 12B and 12C are in this embodiment plumbed together via an interconnecting line 18 so that the three storage tanks 12B/C/D are arranged in series. The storage tanks 12B/C/D and remaining storage tank 12A together with the interconnecting pipes 14A/B provide a buffer for the storage of filtered rainwater.

Additionally, tank 12D in FIG. 2 may include a discharge overflow in the event that the irrigation system or supplementary water supply does not extract sufficient water from the system 10.

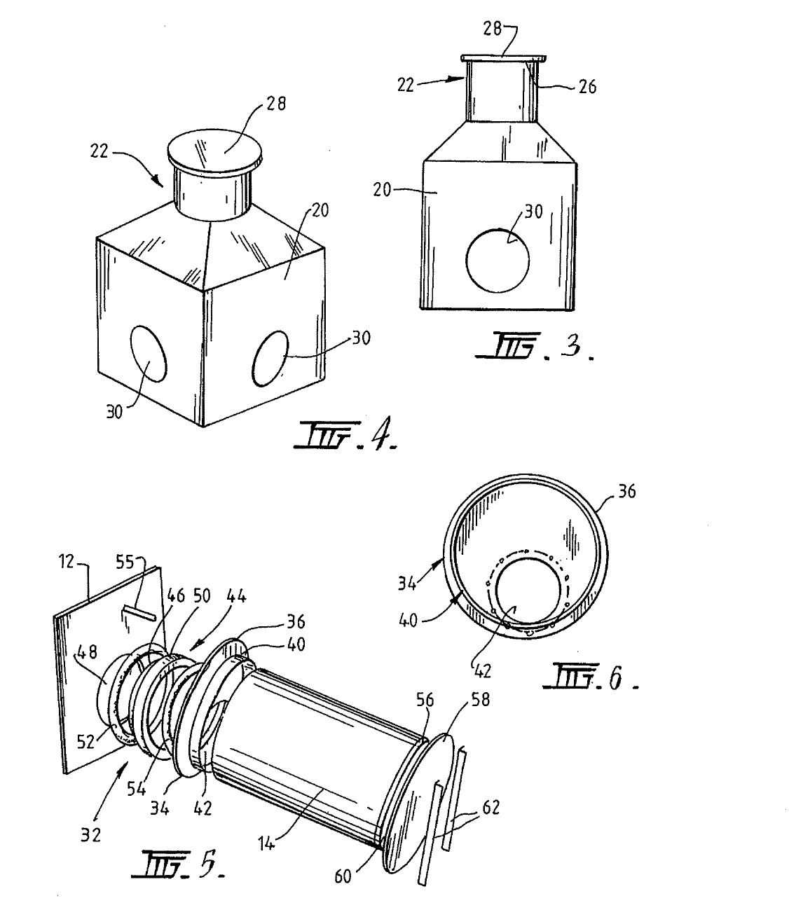

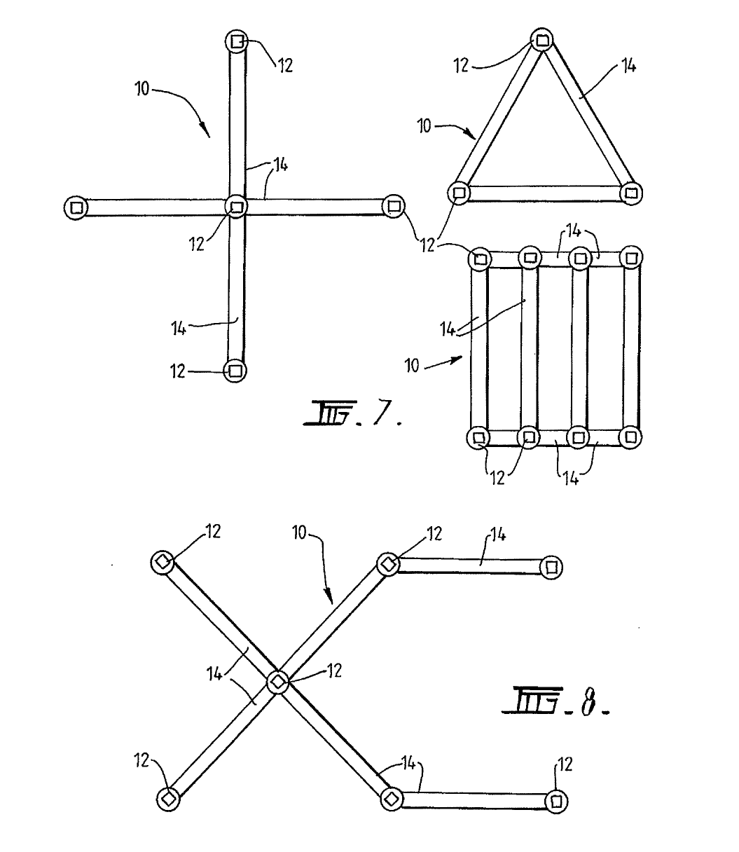

As shown in FIGS. 3 and 4, the storage tanks 12, 12A/B/C are substantially square in profile with a relatively large minimum cross-sectional dimension that is greater than the cross-sectional dimension of the or each pipe connected to it. The minimum cross-sectional dimension of each tank will typically be at least 1.6 m and more preferably, 1.8 m or greater. The storage tanks are moulded from a plastics material which in the tank shown in FIGS. 3 and 4 is a high density polyethylene (HDPE). The tank has a perimeter wall 20 of a thickness sufficient to provide the required structural rigidity to the tank. With further reference to FIGS. 3 and 4, the tank also includes a head assembly 22 in an upper region of the tank consisting of a riser 24 with an access opening in the form of a manhole 26. A manhole cover 28 is removably secured to the riser 24 closing the tank. Typically, the manhole cover will be bolted to the upper rim of the riser by way of a plurality of bolts located in corresponding apertures spaced around the manhole opening and threadably received by the riser. Alternatively, the manhole cover itself may be threadably engaged with the riser.

An outwardly protruding convex formation generally indicated by the numeral 30 is provided in each side of the perimeter wall 20 of the tank shown in FIGS. 3 and 4. The convex formations define locations for connection of pipes 14 to the tank depending on the particular requirements of the application and water retention/ detention system design. Specifically, to connect a pipe to the tank, the convex formation in the perimeter wall is cut along its outer periphery to provide an opening into the interior of the tank. A connection fitting is then used to connect the pipe to the tank such that the pipe opens to the interior of the tank through the opening. The location and size of the opening is thereby predetermined by the position of the convex formation, facilitating the connection of the pipe to the tank and thereby the installation of the system. Rather than a convex fonnation, a tank 12 may be provided with a convex formation or a raised annular ring formation for identifying the region of the peripheral wall to be removed to form the opening into the tank.

Typically, the tank 12 will further incorporate integrally moulded rib structures reinforcing the tank and particularly, the perimeter wall of the tank. The rib structures may be provided on the tank in any pattern suitable for reinforcement of the tank. As will be understood, when buried, the majority of the tank will be below surface with preferably only the manhole cover being visible at ground level. While the tank shown in FIG. 3 and FIG. 4 are square in shape, tanks with a round outer profile or other rectilinear profile, or combination thereof, may also be employed.

The tanks 12, 12A/B/C will normally have a water storage capacity of from about 3,500 litres up to about 500,000 litres or more depending on the particular application. Preferably, the tanks 12 will have a water storage capacity in a range of from about 3,500 litres to about 150,000 litres and more preferably, from about 3,500 litres to about 40,000 litres. As such, the tanks are relatively large, permitting ready access via the manhole 26 into the tanks for maintenance/installation. Usually, the openings through which the pipes are connected to the tank 5 will also be sufficiently large to allow access from the interior of the tank into the pipes for maintenance/installation purposes.

One or more tanks 12, 12A/B/C of a water retention or detention system embodied by the invention can also house plumbing such as water inlet line 16 (see FIG. 2) which enters the tank through the upper region thereof, a pump for pumping water from the sump of the tank comprising that region of the tank below respective of the openings through which the pipe(s) open to the tank, associated electrical systems for controlled operation of the pump, and a water discharge line (not shown) for the discharge of water from the tank under the action of the pump. Alternatively, in the case of a water detention system, the tank may have one or more discharge openings plumbed to conduits for the controlled discharge of water from the sump of the tank to a water catchment pit, dam or drainage system. A tank may also house filter(s) for filtering water entering the tank and/or being discharged from the tank. As will be understood, suitable connection fittings for entry or exit of water inlet line(s) 16 or water discharge lines into or from the tank may also be fitted to the tank.

The pipes 14, 14A/B shown in FIGS. 1 and 2 are corrugated steel pipes. The corrugated steel is relatively light gauge and is spiral wound and coated with HDPE or other suitable polymer for protection of the pipes against corrosion. Such polymer coated pipes are commercially available and any suitable such pipes may be utilised. The pipes are typically of a diameter in a range of from about 900 mm to 1,500 mm or more. Generally, the diameter of a pipe, that is, its minimal cross-sectional dimension, will be less than the corresponding minimum cross-sectional dimension of each tank in the section of the tank to which it is connected. While corrugated steel pipes are preferred, pipes with plain or other ribbed surface profiles may be utilised. The pipes can also, for instance, be predominantly or entirely fabricated from a plastics material. While pipes having round profiles are preferred, pipes of other cross-sectional shapes can also be utilised.

A connection fitting generally indicated by the numeral 32 for connecting a pipe 14 to a tank 12 is shown in FIG. 5. The connection fitting comprises an end cover 34 including an end cover plate 36 for covering an open end 38 of the pipe and an annular collar 40 for reception within the open end of the pipe in a clearance fit to hold the end cover in position. An orifice 42 smaller than the minimum cross-section of the pipe is defined in the end cover plate 36 of the end cover. The orifice is offset downwardly with respect to the longitudinal access of the pipe such that the bottom periphery of the orifice defined by the collar 40 is substantially aligned with the bottom surface of the interior of the pipe, allowing water to empty from the pipe into the tank in use.

A flanged element in the form of a polyethylene stub flange 44 is also provided for being sandwiched between the tank 12 and the end cover. The stub flange incorporates a centrally disposed ring member 46 for insertion into the opening 48 of the tank to locate the connection fitting 32 in position, and a relatively thick end flange 50 projects laterally from the other end of ring member 46. The thickness of the stub flange provides structural support to the perimeter wall of the tank 12 about the respective opening to the interior of the tank and spaces the end cover plate 36 from the tank to accommodate any integrally formed reinforcement ribs of the perimeter wall provided in the vicinity of the opening

The connection fitting also incorporates a pair of flexible gaskets 52 and 54 provided to prevent leakage of water, one of the gaskets being sandwiched between the stub flange 44 and the tank 12 and the other of the gaskets being sandwiched between the stub flange 44 and the end cover plate 36 of the end cover 34. Each of the gaskets 52 and 54 and the stub flange 44 are provided with circumferentially located apertures (not shown) spatially aligned with those provided in the end cover plate for the securing of the connection fitting to the tank by way of corrosion resistant bolts. An air equaliser tube 55 projects from the tank 12 and is sealingly connected to the top side of the pipe 14 via an elbow (not shown) for allowing the passage of air between the interior of the pipe and the tank as the water level within the water retention or detention system rises or falls.

The pipe 14 is secured to the collar 40 of the end cover 34 by drilling holes around the periphery of the pipe and riveting the pipe to the collar through the holes. Conventional “pop rivets” can be used for this, although it will be understood that other fasteners suitable for fixing the pipe to the collar of the end cover 34 of the connection fitting 32 may also be used. In the embodiment shown, the opposite end 56 of the pipe 14 is closed by a terminal end cover 58 with a projecting collar 60 mechanically fastened to the pipe 14 in the same manner as the end cover 34. Strip angles 62 are mechanically fixed to the terminal end cover 58 providing structural support to that end cover.

Once the pipe 14 is connected to the tank 12, polyethylene beading is applied along the exposed seams within the pipe formed between the collars of the end cover 34 and terminal end cover 58. HDPE liners may also be fixed to any exposed metal surfaces of the end cover 34 of the connection fitting and the terminal end cover 58 with appropriate adhesives, and exposed seams covered by polyethylene beading to prevent leakage of water and corrosion of metal surfaces. Accordingly, the connection of the pipe to the tank will normally be sealed against leakage of water from the retention or detention system. Other pipes with a larger minimum cross-section can also be connected to the tank using a correspondingly sized connection fitting 32 for the pipe without modifying the size of the opening 48.

As such, the use of a connection fitting 32 allows one or more pipes 14 to be selected from a range of pipe sizes for a given water storage tank size to provide a water retention/detention system of a desired capacity for a particular site. As will also be understood, the use of connection fittings 32 allows differently sized pipe(s) to be fitted to the tank(s) 12 without the need to cut differently sized openings in the tank(s) dependent on the size of the pipe utilized.

A pipe 14, 14A/B may also be connected to a storage tank 12, 12A/B/C by other embodiments of connection fittings. For example, the connection fitting may include a generally elongated ring member having an annular flange formed at one end. The ring member is shaped complementary to the opening and in this embodiment, is a clearance fit within the opening. The ring member is heavy walled and provides structural support for the tank about the opening and thereby reinforcement of the perimeter wall of the tank. The annular flange is arranged to abut an inner surface of the perimeter wall to also provide structural support to the perimeter wall, and a seal is provided about this contacting portion of the annular flange. The ring member is of sufficient length to protrude from the tank for connection to the pipe, and thus provides a spigot about which the pipe is fitted. The pipe is a clearance or tolerance fit about this ring member and can be securely clamped to the ring member by a ring clamp. The connection fitting of this embodiment, as with the embodiment shown in FIG. 5, thus serves the dual purpose of reinforcing the tank about an opening of the tank and provides means for connection of the pipe to the tank.

The connection fitting described immediately above can also be integrally formed with the tanks 12, 12A/B/C. In this case, the tanks may be rotary moulded in polyethylene (HDPE) and the connection fitting 61 will take the form of a moulded boss rather than having to rely on a separate collar and reinforcing ring member arrangement as in the preceding embodiment.

The use of connection fittings that provide structural support to the perimeter wall of the tank as described above enhances the load carrying capacity of the systems in-situ, reducing the risk of damage from occurring and facilitating location of the system in positions subject to increased loads. For example, a pipe 14, 14A/B may be located under a road or thoroughfare wherein the pipe interconnects tanks 12, 12A/B/C positioned to each side of the road or thoroughfare. In instances where larger pipes are utilised necessitating the pipes and tanks to be buried more deeply, the height of the risers of the tanks may be increased to accommodate the greater depth at which the system is buried. In particularly preferred embodiments, the riser may be cut to the required height during installation on site.

The general steps involved in installation of, for example, the stormwater detention and rainwater retention systems 10 of FIGS. 1 and 2 are as follows:
(a) the site is excavated depending on the layout of tanks 12, 12A/B/C and pipes 14, 14A/B required for the particular application;
(b) the pipes are cut to the required length(s) and the respective openings are cut or otherwise formed in the tanks 12 at the required location;
(c) the tanks and pipes are positioned in the excavated trenches and the pipes are connected to the corresponding tank(s); and
(d) the stormwater retention or detention system (where applicable) is plumbed or otherwise connected to supplementary services or supplies and the tanks and pipes then buried.

FIGS. 7 and 8 illustrate variations on the layout of the retention/detention systems of FIGS. 1 and 2. In each example, the tanks such as 12A are designated as “nodes” into which a number of pipes 14 join. For ease of reference, corresponding reference numerals have been used for these variants of the detention/retention systems.

Now that preferred embodiments of the invention have been described in some detail it will be apparent to those skilled in the art that the described systems may have one or more of the following advantages:
(a) the storage tanks are of a relatively large cross-sectional area providing access for installation and maintenance/servicing of the installation;
(b) the reinforcement/connection fittings provide structural rigidity to the perimeter walls of the tanks about openings 48 allowing loads to be carried without the use of additional reinforcing components;
(c) the modular design of the tanks and pipes allows versatility and flexibility in the layout and
(d) configuration of water retention/detention systems; and
(e) installation of the water retention/detention systems is relatively quick and can be formed on site with minimal trade skills.

Those skilled in the art will appreciate that the invention described herein is susceptible to variations and modifications other than those specifically described. For example, the tank and/or pipe may be fabricated or formed from materials different to those described. The water retention or detention systems may also vary in layout from those embodiments described dependent on the application and site restrictions. For example, use in connection with building and housing structures may dictate that the systems be located about the perimeter of the structure.

Accordingly, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. An underground water retention or detention system, comprising:
at least one water storage tank adapted for being at least partially buried and having an access entry provided in an upper region of the tank and one or more openings into the interior of the tank provided in a lower region of the tank; and
at least one pipe for storing water and connected to the tank such that the pipe opens to the interior of the tank through a respective said opening, the pipe having a minimum cross-sectional dimension that is less than a dimension of the tank in a section of the tank to which the pipe is connected.

2. A system according to claim 1 further comprising a connection fitting connecting the or each pipe to the tank and having an orifice offset downwardly with respect of the longitudinal axis of the pipe and aligned with the respective opening for emptying of water from the pipe, the orifice being smaller than an internal minimum cross-section of the pipe.

3. A system according to claim 2 wherein the connection fitting includes an end cover in which the orifice is defined, with the end cover covering an open end of the pipe.

4. A system according to claim 3 wherein a bottom periphery of the orifice in the end cover of the connection fitting is substantially aligned with the bottom of the interior of the pipe.

5. A system according to claim 1 being a water retention system for supplying water on demand.

6. A system according to claim 1 wherein the minimum cross-sectional dimension of the tank is at least 1.4 times that of the pipe.

7. A system according to claim 1 wherein the entry access of the tank is a manhole permitting access into at least the tank.

8. A system according to claim 1 comprising a plurality of the tanks interconnected by the at least one pipe.

9. A system according to claim 1 wherein the, or each, storage tank is formed of a plastics or polymeric material.

10. A system according to claim 1 wherein the pipe is a spirally wound corrugated steel pipe.

11. A system according to claim 10 wherein the pipe is polymer coated.

12. A storage tank of an underground water retention or detention system, the storage tank adapted for being at least partially buried, and including:
an access entry provided in an upper region of the tank and one or more openings to the interior of the tank provided in a perimeter wall of the tank in a lower region of the tank; and
a reinforcement fitting fitted to the or each opening providing structural support to the perimeter wall of the tank about the one or more openings.

13. A storage tank according to claim 12 wherein the reinforcement fitting comprises an annular flange contacting an inner surface of the perimeter wall and a ring member projecting from the flange through a corresponding one of the openings for connection of a corresponding pipe to the tank such that the pipe opens to the interior of the tank through the opening.

14. An underground water retention or detention system, comprising:
a plurality of water storage tanks, each adapted for being at least partially buried and having an access entry provided in an upper region of the tank and one or more openings into the interior of the tank provided in a lower region of the tank; and
a plurality of connection fittings each dedicated to a respective one of the openings of the tanks and being adapted to provide for connection of a pipe for interconnection of ones of the tanks, the positioning of the openings in the tanks being dependent on the orientation of the pipe and relative disposition of the storage tanks to which the pipe is connected.

15. A system according to claim 14 wherein the pipe has an internal minimum cross-section larger than at least one said opening of the tanks to which the pipe is connected, and a corresponding one of the connection fittings has an orifice offset downwardly with respect to the longitudinal axis of the pipe and aligned with the opening for emptying of water from the pipe, the orifice being smaller than the cross-section of the pipe.

16. A system according to claim 15 wherein the corresponding connection fitting includes an end cover in which the orifice is defined, the end cover covering an end of the pipe.

17. A system according to claim 16 wherein a bottom periphery of the orifice in the end cover of the connection fitting is substantially aligned with the bottom of the pipe.

18. A system according to claim 14 wherein the respective openings are defined in a perimeter wall of the tank and the connection fittings are adapted to provide structural support to the perimeter wall about respective of the openings.

19. A system according to claim 18 wherein each of the connection fittings comprise an annular flange contacting an inner surface of the perimeter wall and a ring member projecting from the flange through the corresponding opening for reception by the pipe.

20. An underground water retention or detention system, comprising:
at least one water storage tank adapted for being at least partially buried, and having an access entry provided in an upper region of the tank and one or more openings into the interior of the tank provided in a lower region of the tank, the openings being of a predetermined size;
at least one pipe for storing water and having a minimum internal cross-section larger than respective of the openings; and
at least one connection fitting interposed between the pipe and the tank and connecting the pipe to the tank such that the pipe opens to the interior of the tank through a respective said opening, the or each connection fitting having an orifice smaller than the minimum cross-section of the pipe and which is offset downwardly with respect to a longitudinal axis of the pipe and aligned with the opening for allowing water to empty from the pipe.

21. A system according to claim 20 wherein the or each connection fitting includes an end cover in which the orifice is defined, the end cover covering an end of the pipe to which it is connected.

22. A system according to claim 21 wherein a bottom periphery of the orifice in the end cover of the or each connection fitting is substantially aligned with the bottom of the interior of the pipe.

23. A system according to claim 20 wherein the entry access of the tank is a manhole permitting access into at least the tank.

24. A system according to claim 20 comprising a plurality of the tanks interconnected by the at least one pipe.

25. A system according to claim 20 wherein the, or each, tank is formed of a plastics or polymeric material.

26. A system according to claim 20 wherein the pipe is a spirally wound corrugated steel pipe.

27. A system according to claim 26 wherein the pipe is polymer coated.

28. A method for providing an underground water retention or detention system, comprising:
providing at least one water storage tank adapted for being at least partially buried, the tank having an access entry in an upper region of the tank;
forming one or more openings to the interior of the tank in a lower region of the tank, the opening or openings being of a predetermined size;
selecting at least one pipe for storing water, the pipe having an interior minimum cross-section larger than at least one of the openings;
providing a connection fitting for connecting the pipe to the tank, the connection fitting having an orifice smaller than the minimum cross-section of the pipe; and
connecting the pipe to the tank using the connection fitting such that the pipe opens to the interior of the tank through a corresponding said opening, the orifice of the connection fitting being offset downwardly with respect to the longitudinal axis of the pipe and aligned with the opening for allowing water to empty from the pipe when the pipe is connected to the tank by the connection fitting.

29. A method according to claim 28 wherein the connection fitting includes an end cover for covering an open end of the pipe and in which the orifice is defined.

30. A method according to claim 28 wherein a bottom periphery of the orifice in the end cover of the connection fitting is substantially aligned with the bottom of the interior of the pipe.

31. A method according to claim 28 wherein the at least one pipe is selected from a plurality of pipes, the minimum cross-section of the pipes being in a range of sizes larger than the predetermined size of respective ones of the openings.

32. A method according to claim 28 comprising interconnecting a plurality of the tanks using the at least one pipe.

33. A method according to claim 28 wherein the, or each, storage tank is formed of a plastics or polymeric material.

34. A method according to claim 28 wherein the pipe is a spirally wound corrugated steel pipe.

35. A method according to claim 34 wherein the pipe is polymer coated.

36. A water storage tank suitable for an underground water retention and/or detention system, wherein the tank is adapted for being at least partially buried and has at least one formation provided in a predetermined location on a perimeter wall of the tank, the formation defining a region of the perimeter wall of predetermined size for being removed to provide an opening in the perimeter wall for connection of a water storage pipe to the tank such that the pipe opens to the interior of the tank through the opening.

37. A water storage tank according to claim 36 provided with a plurality of the formations, with the formations being spaced apart from one another around the perimeter wall of the tank.

38. A water storage tank according to claim 36 having a water storage capacity of at least 2,500 litres.

39. A water storage tank according to claim 36 wherein the tank is formed of a plastics or polymeric material.

40. A connection fitting suitable for connecting a water storage pipe to a water storage tank of an underground water retention and/or detention system, the tank having an access entry provided in an upper region of the tank and at least one opening into the interior of the tank provided in a lower region of the tank, wherein the connection fitting comprises an end cover for covering an open end of the pipe, the pipe having a minimum cross-section larger than the opening of the tank, and wherein the end cover has an orifice smaller than the minimum cross-section of the pipe and is adapted for alignment of the orifice with the opening in the tank.

41. A connection fitting according to claim 40 comprising an end plate in which the orifice is defined and an annular collar projecting from the end plate for insertion into the open end of the pipe for fixing of the pipe to the collar.

42. A connection fitting according to claim 41 wherein a plurality of through apertures are formed in the end plate for reception of fasteners for fastening the end plate to the tank, the apertures being spaced apart from each other around the orifice.

43. A connection fitting according to claim 41 further comprising a flanged element incorporating a ring member for insertion into the opening of the tank and an annular flange for being sandwiched between the end plate and the tank.

44. A connection fitting according to claim 43 further comprising a pair of gaskets, one of the gaskets for being sandwiched in position between the flanged element and the tank and the other of the gaskets for being sandwiched in position between the flanged element and the end plate.

45. A connection fitting according to claim 40 wherein a bottom periphery of the orifice of the end cover is located for being substantially aligned with the bottom of the interior of the pipe.
